(19) United States
(12) Patent Application Publication
(10) Pub. No.: US 2014/0054511 A1
(43) Pub. Date: Feb. 27, 2014

(54) Method for transferring phases of nanoparticles

(71) Applicant: National Tsing Hua University, Hsinchu (TW)

(72) Inventors: Kan-Sen CHOU, Hsinchu (TW); Yi-Chu CHEN, Hsinchu (TW)

(73) Assignee: National Tsing Hua University, Hsinchu (TW)

(21) Appl. No.: 13/960,254

(22) Filed: Aug. 6, 2013

(30) Foreign Application Priority Data
Aug. 27, 2012 (TW) 101130979

(51) Int. Cl. H01B 1/20; H01B 1/22

(52) U.S. Cl. CPC H01B 1/20; H01B 1/22
USPC 252/503; 252/519.3; 252/514; 252/506; 252/519.34

(57) ABSTRACT

The present invention provides a method for transferring phases of nanoparticles, which use a polymer with a molecular weight greater than 5,000 as a dispersant. The first step of the method of the present invention is to synthesize nanoparticles in the polymer aqueous solution. Next, an amphiphilic phase-transfer agent is added into the solution to coat the surface of nanoparticles with bipolar molecules, and then the mixture is added into an organic solvent to form a homogeneous solution. Finally, a salt and an alcohol are added into the homogeneous solution, and then an organic phase layer and an aqueous phase layer through a centrifugal method. The method of the present invention combines the advantages of aqueous process for preparing nanoparticles and transfers the same with a simple phase transferring process to obtain oil-phase nanoparticles, which can be applied to various fields.

### CROSS REFERENCE TO RELATED APPLICATION

This application claims the benefits of the Taiwan Patent Application Serial Number 101130979, filed on Aug. 27, 2012, the subject matter of which is incorporated herein by reference.

### BACKGROUND OF THE INVENTION

1. Field of the Invention

The present invention relates to a method for transferring phases of nanoparticles, more particularly, to a method for transferring nanoparticles from an aqueous phase solution into an oil phase solution by using a polymer dispersant.

2. Description of Related Art

In 1959, a lecture “There's Plenty of Room at the Bottom” published by Feynman started the development of nanotechnology. Nanotechnology is a technique related to atoms, molecules, quantum dots and polymers. In addition, various methods for manufacturing the same have been developed, such as oil phase methods and aqueous phase methods.

Nanoparticles such as quantum dots can be used as a material of nano-scale semiconductor. When quantum dots are used as an active part of a semiconductor laser, the applications thereof can be greatly increased due to low threshold current density, high characteristic temperature (T0), high gain, narrow spectral line width, and low sensitivity to temperature. Recently, literatures related to the method for applying the quantum dots to the solar cell are also published. The light absorption efficiency of the solar cell using the quantum dots can be enhanced since the quantum dots can additionally absorb the light with low energy. In addition, the transporting rate of charge carriers into P type and N type semiconductors can be accelerated to improve the photoelectric conversion efficiency.

Silver nanoparticles, especially water-soluble silver nanoparticles, are one of the widely used nanoparticles owing to simple manufacturing process, low cost and mass production thereof. Besides, silver-nanoparticles can be suspended well and have excellent stability; therefore, they can be widely used as catalysts and antibacterial materials.

In order to disperse nanoparticles well in the paste during the aqueous manufacturing process, polymers such as polyvinylpyrrolidone (PVP) and polyvinyl alcohol (PVA) have to be used as a dispersant, in which PVP has a molecular weight of 25,000 to 300,000, and PVA has a molecular weight of 5,000 to 700,000. In comparison with the dispersants having low molecular weights, the above dispersants (PVA or PVP) have excellent coating ability and stability to the nanoparticles. Therefore, the conditions for the manufacturing process of the nanoparticles can be easily modified based on different nanoparticles and applications when the above dispersants (PVA or PVP) are used.

In the manufacturing process of the nanoparticles, the aqueous phase process is cheaper and simpler than the oil phase process, so the main process for manufacturing the nanoparticles is the aqueous phase process. In recent years, the applications of nanoparticles are gradually increased. For example, quantum dots can be applied in photoelectronics and semiconductors; and silver-nanoparticle paste can be applied in antibacterial fiber cloth and conductive ink for circuits. Even though the aqueous phase process thereof has more benefits than the oil phase process thereof, short circuit phenomena may be caused when the nanoparticles manufactured through the aqueous phase process using insulated polymer dispersants are applied in photoelectronics. Therefore, the oil phase process thereof still has to be developed.

The conventional oil phase process for manufacturing silver nanoparticles comprises pyrolysis method, organometallic reduction, and biphase (oil/aqueous) transferring method. However, the oil phase process exists some deficiencies. For example, the conditions for the pyrolysis method is severer than the aqueous phase process due to its long heating time and atmosphere control. In organometallic reduction, raw materials used therein are more expansive than that used in the aqueous phase process, so this method cannot meet the industrial requirement of mass production. In addition, in biphase (oil/aqueous) transferring method, because no dispersant is exist in the aqueous-phase gel, the nanoparticle concentration in the aqueous-phase gel has to be low enough to disperse well. Therefore, the biphase (oil/aqueous) transferring method cannot transfer the phases of the nanoparticles in high concentration, so the efficiency thereof is low.

Owing to the oil phase transferring method has the aforementioned defects, it is necessary to provide an improved oil phase transferring method to obtain oil-phase nanoparticles simply and effectively.

### SUMMARY OF THE INVENTION

The object of the present invention is to provide a method for transferring nanoparticles from an aqueous phase solution into an oil phase solution. In the present invention, the nanoparticles prepared through a simple aqueous phase process can be transferred into an oil phase solution at room temperature, so as to improve the application fields of the nanoparticles.

Another object of the present invention is to provide a method for transferring phases of nanoparticles, in which the nanoparticles with high concentration can be transferred into the oil phase layer by increasing the dispersion of the nanoparticles with polymers.

To accomplish the above object, a plurality of nanoparticles is firstly synthesized and dispersed uniformly in a polymer solution, wherein polymers contained in the polymer solution have a molecular weight of 5,000 or more. Then, a phase-transfer agent is added into the polymer solution to form a mixture. An oil phase solvent is added into the mixture to form a homogeneous solution under stirring. Finally, a salt or an alcohol is added in the homogeneous solution to separate the oil phase layer and the aqueous phase layer of the homogeneous solution, and nanoparticles dispersed in polymer solution can be successfully transferred into the oil phase solvent by the method of the present invention.

The nanoparticles used in the present invention, which are protected and dispersed by polymers, are not particularly limited, and can be metal nanoparticles, semiconductor nanoparticles or inorganic nanoparticles. In addition, the polymer contained in the polymer solution is used as a dispersant, which is basically a water-soluble polymer, such as polyvinylpyrrolidone (PVP), polyvinyl alcohol (PVA), polyethyleneimine (PEI), polymethylvinylether (PVM), polyethylene glycol (PEG) and polyethyleneimine (PEI), and polyvinylpyrrolidone (PVP). Preferably, the polymer used herein is polyvinyl alcohol (PVA).

The phase-transfer agent used in the present invention is adsorbed on the surfaces of nanoparticles before the step of adding the oil phase solvent. The phase-transfer agent is an amphiphilic molecule having a hydrophobic end and a hydrophilic end, in which the phase-transfer agent is adsorbed on the surface of nanoparticles through the hydrophilic end, and the hydrophobic end can assist the suspension of the nanoparticles in the oil phase solvent to transfer the nanoparticles from the aqueous phase into the oil phase. Preferably, the phase-transfer agent can be sodium oleate and 1-dodecanethiol, and the oil phase solvent can be any organic solvent, such as toluene, benzene, chloroform, and hexane. However, the present invention is not limited thereto.

The purpose of adding the salt and the alcohol into the homogeneous solution is to make the polymer attached on the surface of nanoparticles, such as polyvinylpyrrolidone (PVP) and polyvinyl alcohol (PVA), exchange with the phase-transfer agent in the oil phase solvent, so as to successfully transfer those nanoparticles from the aqueous solvent into the oil phase solvent. After separating the oil phase and the aqueous phase from the homogeneous solution through the centrifugal method, the nanoparticles will finally be transferred into the oil phase solution. The salt used in the present invention can be sodium chloride or magnesium chloride, and the alcohol used in the present invention can be propanol, butanol and pentanol. However, the salt and the alcohol used in the present invention are not particularly limited thereto.

A fiber material such as carbon nanotubes, glass fibers and polymer fibers can be further added into the oil phase solvent dispersed with the nanoparticles, to increase the affinity of the nanoparticles to a surface of an object. For example, silver nanoparticles dispersed in the oil phase solvent can be used to prepare a silver paste by heat-treating the silver nanoparticles adsorbed on the fiber material to form a silver film, and then blending the silver film with a gel.

It is worth to be mentioned that the polymer used in the present invention, such as polyvinylpyrrolidone (PVP) and polyvinyl alcohol (PVA), has excellent coating ability and stability. Comparing with the common dispersant having low molecular weight, polymers used in the present invention have excellent dispersion ability, which can improve the phase transferring effect of nanoparticles in a high concentration.

The shape and the size of nanoparticles can be altered through adjusting the concentration of the polymers and the nanoparticles due to the bonding between the polymers and the nanoparticles. In this case, nanoparticles such as nano-plates, nanowires, nano-rods, nano-spheres and nano-sheets can be obtained. In addition, the light absorption spectra of the nanoparticles may be varied as the shapes thereof changed. Therefore, the nanoparticles with different shapes can be applied to different application fields. For example, a surface of a PET film can be coated with silver nano-wires to form a transparent conductive film, and silver nano-spheres can be manufactured into a conductive ink solution. As a result, in the present invention, the applications of nanoparticles can be extended by altering the shapes of nanoparticles through adjusting the concentration of the polymers and the nanoparticles.

Furthermore, the method of the present invention can be performed at room temperature and under atmospheric environment. Therefore, the manufacturing method of nanoparticles can be simplified by using the method of the present invention, and satisfy the requirements for commercialization.

Other objects, advantages, and novel features of the invention will become more apparent from the following detailed description when taken in conjunction with the accompanying drawings.

### BRIEF DESCRIPTION OF THE DRAWINGS

The following detailed description will make a person skilled in the art further understand the present invention by referring to the following drawings. However, it should be understood that the following examples are just for the purpose of illustration, and not used to limit the scope of the present invention.

FIG. 1 is a diagram showing a process of the method for transferring phase of nanoparticles of the present invention;

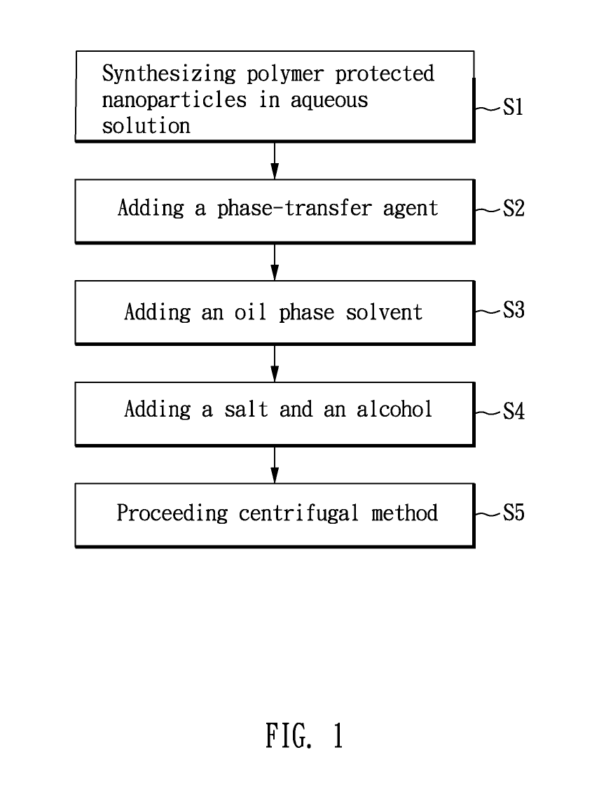

FIG. 2 is a graph showing Fourier transform infrared (FTIR) spectra of PbS nanoparticles according to Embodiment 1 of the present invention;

FIG. 3 is a transmission electron microscopy (TEM) photo of PbS nanoparticles according to Embodiment 1 of the present invention; and

FIG. 4 shows light absorption spectra of PbS nanoparticles before and after the phase transferring process in according to Embodiment 1 of the present invention.

### DETAILED DESCRIPTION OF THE PREFERRED EMBODIMENT

The following embodiments of the present invention will be further described by the accompanied figures. It should be understood that all of the embodiments are described for illustration, but not used to limit the scope of the present invention.

### Embodiment 1

### Transferring Phases of Lead Sulfide (PbS) Quantum Dots

A sodium sulfide (NaS) aqueous solution was added into a PVA solution containing lead nitrate (Pb(NO₃)₂) drop by drop to form lead sulfide (PbS) nanoparticles. The concentration of the PbS nanoparticles (i.e. PbS quantum dots) in the PVA solution was 1.68×10⁻³ M, and the color of the solution containing PbS quantum dots was deep red.

Next, the PbS quantum dots in the PVA solution were dispersed in a sodium oleate solution, and then the hexane was added into the sodium oleate solution under stirring to from a homogeneous solution. Sodium chloride and pentanol were added into the homogeneous solution, and the oil phase solution and the aqueous phase solution were separated through a centrifugal method. The upper layer is the oil phase solution contained with PbS quantum dots, and the bottom layer is the aqueous phase solution. Finally, the upper oil phase solution with PbS quantum dots contained therein was collected for further analysis.

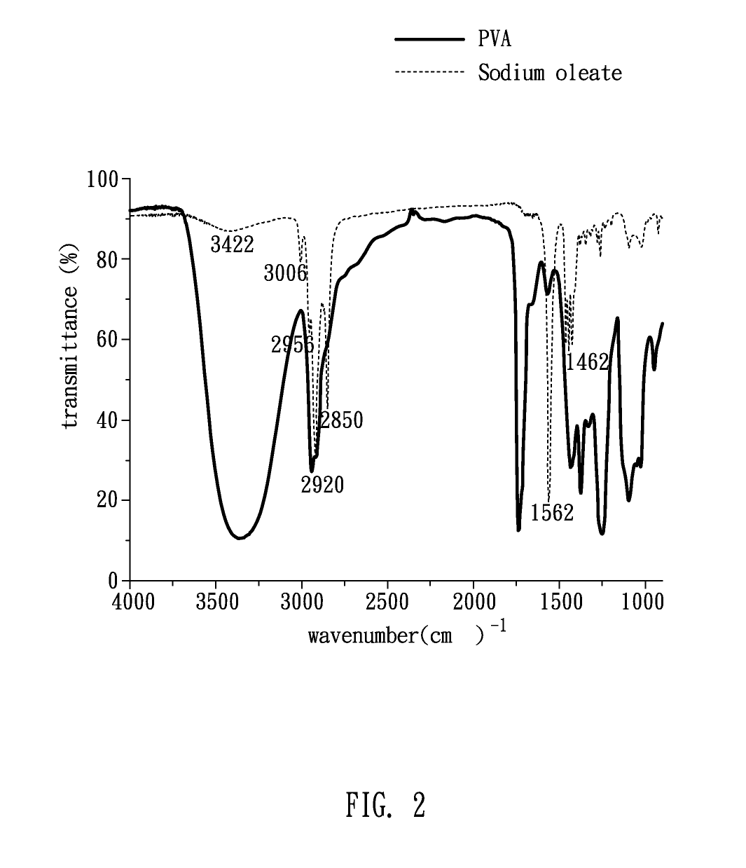

FIG. 2 is a graph showing Fourier transform infrared (FTIR) spectra of the PbS nanoparticles prepared in the present embodiment 1. The FTIR spectrum was the vibration spectrum of the organic material, which was obtained by transforming the interference spectrum through Fourier transform (FT(t)). Function group regions and fingerprint regions can be obtained from the vibration spectrum of the organic material to further accomplish the molecular identification and qualitative and quantitative analysis. As shown in FIG. 2, peaks at 2920 cm⁻¹ and 2850 cm⁻¹ represent —CH function group of —CH₂, that at 1462 cm⁻¹ represents —CH₂, that at 3006 cm ⁻¹ represents ═CH, and those at 3006 cm⁻¹, 2920 cm⁻¹, 2850 cm⁻¹ and 1462 cm⁻¹ represent oleate ions adsorbed on the surface of PbS quantum dots. Therefore, the FTIR spectra shown in FIG. 2 can prove that the oleate ions are adsorbed on the surfaces of PbS quantum dots. Furthermore, the peak at 3422 cm⁻¹ is hardly observed, and it represents that PVA molecules on the surface of the PbS quantum dots is successfully replaced by the oleate ions.

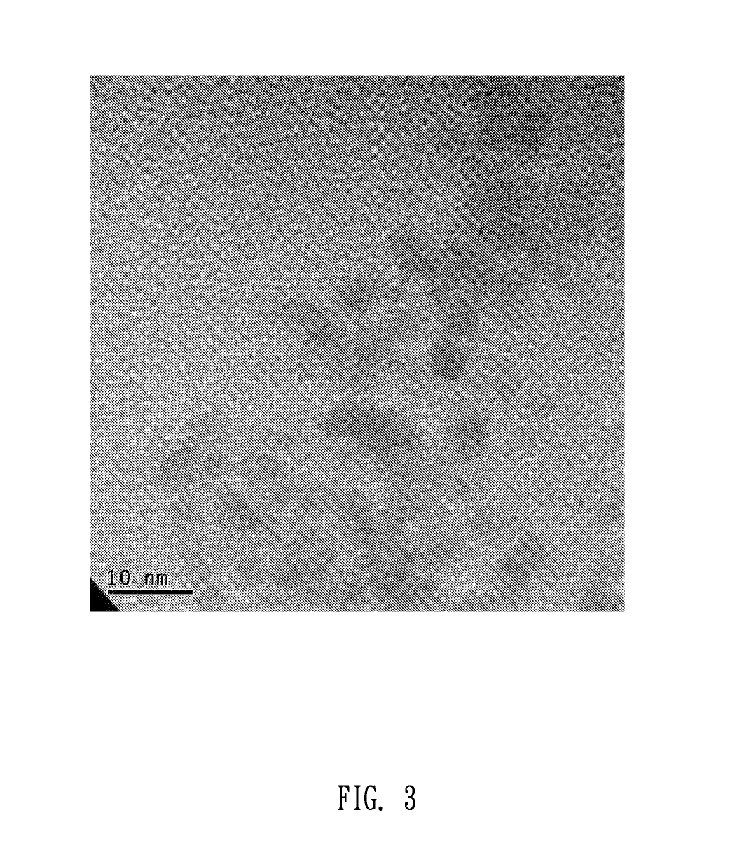

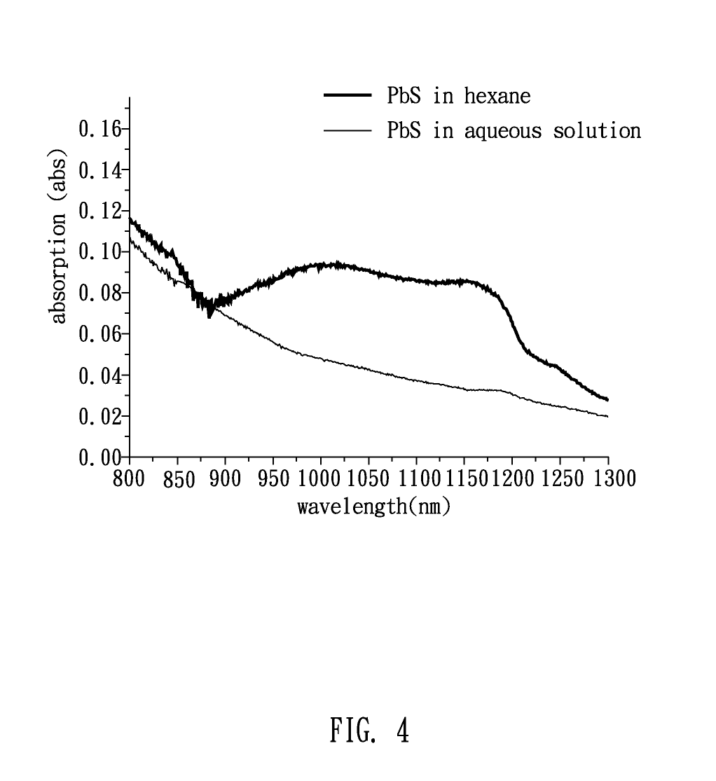

FIG. 3 is a transmission electron microscopy (TEM) photo of PbS quantum dots after the phase transferring process. In FIG. 3, the particle sizes of the PbS quantum dots after the phase transferring process are still in a range of 3-4 nm, and the signal strength thereof is enhanced. In the light absorption spectra of FIG. 4, the signal range of the PbS quantum dots after the phase transferring process was broadened and enhanced from 900 nm to 1200 nm. According the result of FIG. 4, the oil-phase quantum dots were successfully manufactured in Embodiment 1, which are useful in the field of solar cells and other optoelectronics.

### Embodiment 2

### Transferring Phase of Silver Nanoparticles

Another embodiment of the present invention is phase transferring process of silver nanoparticles. At room temperature, AgNO₃ was added into polyvinylpyrrolidone (PVP) polymer solution ((wt/wt)=0.25) to a final concentration of 0.1N, and AgNO₃ was reduced into Ag by sodium borohydride to obtain the aqueous-phase silver nanoparticles.

Next, a sodium oleate solution was added into the aqueous solution containing Ag nanoparticles to form a mixture, and then hexane was added therein under stirring to obtain a homogeneous solution. NaCl and the pentanol were added into the homogeneous solution, and the oil phase solution and the aqueous phase solution were separated through a centrifugal method to collect the upper oil phase solution with Ag nanoparticles contained therein.

Although the present invention has been explained in relation to its preferred embodiment, it is to be understood that many other possible modifications and variations can be made without departing from the spirit and scope of the invention as hereinafter claimed.

What is claimed is:

1. A method for transferring phases of nanoparticles, which comprises the following steps:
(A) synthesizing a plurality of nanoparticles in a polymer solution to form a nanoparticle aqueous solution, wherein a polymer contained in the polymer solution has a molecular weight of 5,000 or more;
(B) adding a phase-transfer agent into the nanoparticle aqueous solution, wherein the phase-transfer agent is an amphiphilic molecule having a hydrophobic end and a hydrophilic end;
(C) adding an oil phase solvent into the nanoparticle aqueous solution containing the phase-transfer agent to form a homogeneous solution; and
(D) adding a salt and an alcohol into the homogeneous solution, and separating the homogeneous solution into an oil phase layer and an aqueous phase layer through a centrifugal method, wherein the nanoparticles are contained in the oil phase layer.

2. The method as claimed in claim 1, wherein the polymer solution is selected from a group consisting of polyvinyl pyrrolidone (PVP) and polyvinyl alcohol (PVA).

3. The method as claimed in claim 1, wherein the nanoparticles is selected from a group consisting of metal nanoparticles, semiconductor nanoparticles and inorganic nanoparticles.

4. The method as claimed in claim 1, wherein the phase-transfer agent is selected from a group consisting of a sodium oleate and a 1-dodecanethiol.

5. The method as claimed in claim 1, wherein the oil phase solvent is an organic solvent.

6. The method as claimed in claim 5, wherein the organic solvent is selected from a group consisting of toluene, benzene, chloroform, and hexane.

7. The method as claimed in claim 1, wherein the salt is selected from a group consisting of sodium chloride and magnesium chloride.

8. The method as claimed in claim 1, wherein the alcohol is selected from a group consisting of propanol, butanol and pentanol.

9. The method as claimed in claim 1, further comprising a step of adding a fiber material into the oil phase solution after the step of (D).

10. The method as claimed in claim 9, wherein the fiber material is selected from a group consisting of a carbon nanotube, a glass fiber and a polymer fiber.
